(19) United States
(12) Patent Application Publication
(10) Pub. No.: US 2008/0012334 A1
(43) Pub. Date: Jan. 17, 2008

(54) Clamping arrangement for swimming pool accessories

(76) Inventor: Christian Patron, Blainville (CA)

Correspondence Address: Eric Fincham, 316 Knowlton Road, Lac Brome, QC, J0E 1V0, CA

(21) Appl. No.: 11/481,334

(22) Filed: Jul. 5, 2006

(30) Foreign Application Priority Data
Jul. 5, 2005 (CA) 2,511,383

(51) Int. Cl. F16L 21/00

(52) U.S. Cl. 285/403

(57) ABSTRACT

A clamping arrangement for securing a swimming pool implement 10 to a shaft 19, the arrangement comprising a shaft receiving member 20 which has a wall 21 surrounding a receptacle 22 sized to receive the shaft, a tongue 36 forming a portion of the wall 21 with the tongue 36 having a proximal end 38 connected to the wall 21 and a moveable distal end 40, a clamping member 24 pivotably connected to the wall proximate the distal end 40 of the tongue 36, the clamping member 24 being moveable between an open position and a closed position with the closed position being one wherein the clamping member 24 substantially overlies the tongue 36, the clamping member having a cam portion 30 which is operative to contact the distal end 40 of the tongue such that as the clamping member 24 is moved from the open position to the closed position, the cam surface 32, 34, 35 initially forces the distal end 40 of the tongue 36 inwardly while slightly releasing pressure as the clamping member is moved to the fully closed position.

### FIELD OF THE INVENTION

The present invention relates to a clamping arrangement for pool accessories.

### BACKGROUND OF THE INVENTION

In the swimming pool industry, the joining together of various components for temporary use is widely practiced. Thus, virtually every pool uses a telescoping rod arrangement wherein two cylindrical members are joined together to provide an adjustable length pole. This adjustable length pole is then fitted with various accessories such as a scrubber, a vacuum head, a skimmer net, etc.

With respect to the telescoping pole arrangement, it is known that the same may use a cam lock system wherein a plug is inserted into one end of the inner member. Thus, there is provided an eccentric groove in the projecting portion which receives an eccentric collar. With the collar concentrically positioned in the groove, the telescopic members are free to be adjusted longitudinally with respect to each other. However, when the collar is rotated to an eccentric position relative to the plug-in, the plug-in collars are both forced into frictional engagement with opposite sides of the other member and thereby lock the members in position. This particular type of cam lock can be inconvenient in that it is bi-directional and will lock the telescoping members together when the collar is rotated in either direction relative to the plug.

It is also known in the art to provide an arrangement for locking of the telescoping members wherein the locking action is achieved only when the members are rotated relative to each other in a single predetermined direction.

As previously mentioned, one of the distal ends of one of the poles is designed to receive and secure an accessory such as a skimmer net or a vacuum head. Conventionally, the arrangement for securing the utensil to the pole comprises an arrangement wherein the pole has at least one pair of diametrically opposed apertures which are designed to receive fingers or prongs extending outwardly from a shaft associated with the utensil. The fingers or prongs are normally resiliently biased outwardly by suitable means.

Although the above arrangements are considered standard in the pool industry, there is a need for other means of locking telescoping rods together as well as for securing the swimming pool utensil to the telescoping rod.

### SUMMARY OF THE INVENTION

It is an object of the present invention to provide a basic securing and clamping arrangement which is suitable for attaching a swimming pool utensil to a rod.

It is a further object of the present invention to provide a securing and clamping arrangement which may be utilized with telescoping poles to secure the poles in a desired longitudinal relationship.

According to one aspect of the present invention there is provided a clamping arrangement for securing a swimming pool implement to a shaft, the arrangement comprising a shaft receiving member having a wall surrounding a receptacle, the receptacle being sized to receive the shaft, a tongue forming a portion of the wall, the tongue having a proximal end connected to the wall and a distal end which is moveable, a clamping member, the clamping member being pivotably connected to the wall proximate the distal end of the tongue, the clamping member being moveable between an open position and a closed position, the closed position being one wherein the clamping member substantially overlies the tongue, a cam portion on the clamping member, the cam portion being located proximate the point where the clamping member is pivotably connected to the wall, the cam portion having a cam surface arranged to contact the distal end of the tongue such that as the clamping member is moved from the open position to the closed position, the cam surface initially forces the distal end of the tongue inwardly.

According to a further aspect of the present invention there is provided a clamping arrangement for securing a telescoping pole arrangement in a desired position, the telescoping pole comprising an inner pole and an outer pole, the clamping arrangement comprising a tongue forming a portion of a wall of the outer pole, the tongue having a proximal end connected to the wall and a distal end which is moveable, a clamping member pivotably connected to the wall proximate the distal end of the tongue, the clamping member being moveable between an open position and a closed position, the closed position being one wherein the clamping member substantially overlies the tongue, a cam portion on the clamping member, the cam portion being located proximate the point where the clamping member is pivotably connected to the wall, the cam portion having a cam surface arranged to contact the distal end of the tongue such that as the clamping is moved from the open position to the closed position, the cam surface initially forces the distal end of the tongue inwardly.

The clamping arrangement of the present invention may be utilized for securing a swimming pool implement to a pole or like member. The clamping arrangement may also be utilized with a telescoping pole or for securing one of the pole sections to the other.

In either of the above arrangements, there is provided a shaft receiving member which has a wall surrounding a receptacle formed therein. The receptacle is sized to receive the shaft.

Formed within the wall of the shaft receiving member is a tongue portion. The tongue portion has a proximal end which is formed integrally with the remainder of the wall and a distal end which is free to move due to the flexible nature of the material and the relative thinness of the tongue.

The clamping member is connected to the wall of the shaft receiving member by suitable means. Conveniently, an axle may extend between two wall portions with the tongue having its proximal end mounted on the axle.

A cam is formed at the proximal end of the clamping member, the cam preferably having a first cam surface portion and a second cam surface portion which are angled with respect to each other as will be described in the preferred embodiments hereinbelow.

Preferably, there is also provided a locking arrangement between the tongue and the clamping member when the clamping member is in a closed position.

The clamping arrangement is preferably formed of a plastic material. In the instance wherein the clamping arrangement is used with a telescoping pole, the clamping arrangement may be secured to one end of the outer pole by any suitable means.

It is conventional in the industry that the shafts of both the telescoping poles and swimming pool implements are circular and in the preferred embodiment, the same arrangement is employed. However, it is within the scope of this invention that other cross sectional configurations may be utilized.

### BRIEF DESCRIPTION OF THE DRAWINGS

Having thus generally described the invention, reference will be made to the accompanying drawings illustrating an embodiment thereof, in which:

FIG. 1 is a perspective view of a swimming pool cleaning implement having a clamping arrangement for securing a shaft therein;

FIG. 2 is a side elevational view thereof;

FIG. 3 is an end view of the shaft receiving receptacle;

FIG. 4 is a cross-sectional view taken along the lines 4-4 of FIG. 2 when the clamping member is in an open position;

FIG. 5 is a view similar to FIG. 4 illustrating a partial closing of the clamping member;

FIG. 6 is a cross-sectional view similar to FIG. 4 illustrating the clamping member in a near closed position; and

FIG. 7 is a view similar to FIG. 4 illustrating the clamping member in a locked position.

### DETAILED DESCRIPTION OF THE INVENTION

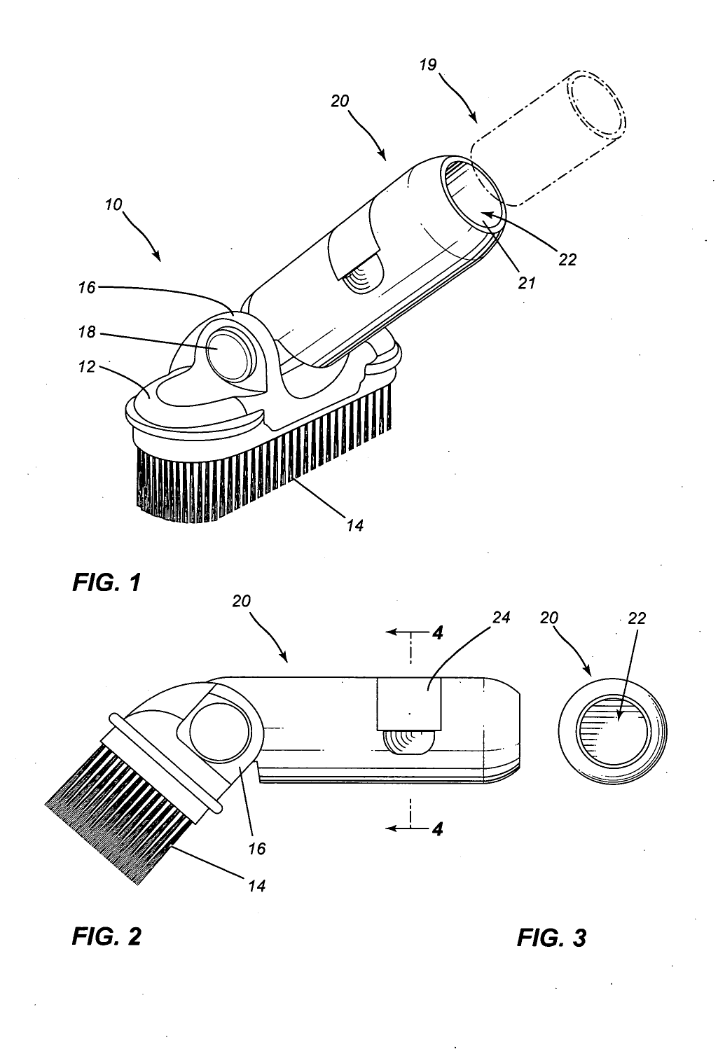

Referring to the drawings in greater detail and by reference characters thereto, there is illustrated in FIG. 1 a swimming pool implement in the form of a brush 10 having a body 12 with bristles 14 extending therefrom. A pair of ears 16 (only one shown) are mounted on top of body 12 to receive an axle 18 on which a shaft receiving member 20 is mounted.

Shaft receiving member 20 has a wall 21 which includes a cylindrically shaped receptacle 22 for receiving a free end of a pole 19 illustrated in dotted lines.

The clamping arrangement includes a clamping member 24 having a proximal end 26 and a distal end 28.

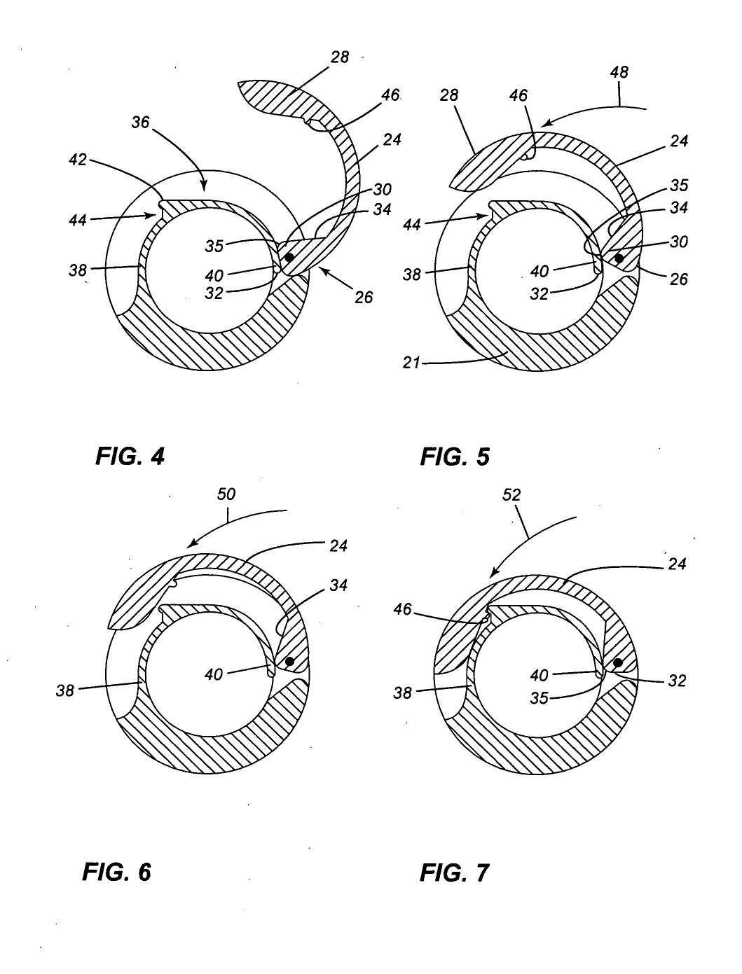

Forming a portion of the shaft receiving member 20 is a tongue 36. Tongue 36 has a tongue proximal end 38 and a tongue distal end 40 which is free to move due to the relative thinness of its design and the flexible nature of the material. As may be seen in FIGS. 4 to 7, tongue 36 has on an exterior surface thereof an enlarged portion 42 which incorporates a recess 44 for reasons which will become apparent hereinbelow.

Clamping member 24 overlies tongue 24 and has a clamping member proximal end 25 and a clamping member distal end 28. Clamping member 24 is secured to shaft receiving member 20 by means of a shaft or axle 29.

Formed at proximal end 26 of clamping member 24 is a cam generally designated by reference numeral 30 and which has a first cam surface portion 32, a second cam surface portion 34, and with a cam transition surface 35 therebetween. First cam surface portion 32 and second cam surface portion 34 are angled with respect to each other and form an angle of less than 90° for reasons which will be discussed hereinbelow.

Formed on the inner surface of clamping member 24 is a locking projection 46 which is designed to fit within recess 44 of tongue 36.

Referring to FIGS. 4 to 7, FIG. 4 illustrates the clamping arrangement wherein the clamping member 24 is in its fully opened position. In this position, receptacle 22 is free to receive pole 19 with the inner surface of tongue 36 forming a portion of the wall 21 surrounding receptacle 22.

In the open position of FIG. 4, first cam surface portion 32 lies adjacent to the outer surface of tongue distal end 40. Also, the edge of tongue 24 may be beveled to aid in the insertion of the pole 19.

Referring to FIG. 5, when clamping member 24 is initially moved towards its closed position as indicated by arrow 48, cam transition portion 35 will cause tongue distal end 40 to move inwardly. As the closing action is continued, as shown in FIG. 6 and by arrow 50, cam 30 moves past its maximum camming action position and tongue distal end 40 is free to move slightly outwardly from its maximum inward position. In so doing, tongue 24 will then move on its own accord to a fully closed position as shown in FIG. 7. In other words, tongue distal end 40 exerts a force on clamping lever 24 to urge it to the fully closed position indicated by arrow 52.

In the above description, tongue distal end 40 is shown as extending inwardly as there is no pole 19 shown as being inserted in receptacle 22. In practice, there is a slight inward movement along with compression of the tongue distal end 40. Also, the edge of tongue 24 may be beveled to aid in the insertion of the pole 19.

As shown in FIG. 7, in the fully closed position, locking projection 47 engages in recess 44 to maintain clamping member 24 in the fully closed position.

It will be understood that while the clamping arrangement is shown between a pole 19 and a swimming pool cleaning implement 10, the same arrangement can be used with telescoping poles as are typically used in a swimming pool. In such an arrangement, the clamping arrangement may be provided as a separate piece similar to shaft receiving member 20 of FIG. 1 and which piece forms the end portion of the outer pole. Alternatively, the poles may be formed of a plastic material incorporating the shaft receiving member 20.

It will be understood that the above described arrangement is for purposes of illustration only and that changes and modifications may be made thereto without departing from the spirit and scope of the invention.

I claim:

1. A clamping arrangement for securing a swimming pool implement to a shaft, the arrangement comprising:
a shaft receiving member 20 having a wall 21 surrounding a receptacle 22, said receptacle being sized to receive said shaft;
a tongue 36 forming a portion of said wall, said tongue having a proximal end 38 connected to said wall and a distal end 40 which is moveable;
a clamping member 24, said clamping member 24 being pivotably connected to said wall 21 proximate said distal end 40 of said tongue 36, said clamping member 24 being moveable between an open position and a closed position, said closed position being one wherein said clamping member 24 substantially overlies said tongue 36; and
a cam portion 30 on said clamping member 24, said cam portion being located proximate the point where said clamping member is pivotably connected to said wall 21, said cam portion having a cam surface 32, 34, 35 arranged to contact said distal end 40 of said tongue 36 such that as said clamping member is moved from said open position to said closed position, said cam surface initially forces said distal end 40 of said tongue 36 inwardly.

2. The clamping arrangement of claim 1 wherein said cam surface 32, 34, 35 is such that following said movement of said distal end 40 of said tongue 36 inwardly, said tongue is permitted to move slightly outwardly upon continued movement of said clamping member 24.

3. The clamping arrangement of claim 2 wherein said tongue 36 and said clamping member 24 interlock 44, 46 when said clamping member is moved to said closed position.

4. The clamping arrangement of claim 2 wherein said pole 19 and said receptacle 22 are cylindrical in configuration.

5. The clamping arrangement for securing a telescoping pole arrangement in a desired position, the telescoping pole comprising an inner pole and an outer pole, the clamping arrangement comprising:
a tongue 36 forming a portion of a wall of said outer pole, said tongue having a proximal end 38 connected to said wall and a distal end 40 which is moveable;
a clamping member 24 pivotably connected to said wall proximate said distal end 40 of said tongue 36, said clamping member 24 being moveable between an open position and a closed position, said closed position being one wherein said clamping member 24 substantially overlies said tongue 36;
a cam portion 30 on said clamping member 24, said cam portion 30 being located proximate the point where said clamping member 24 is pivotably connected to said wall 21, said cam portion having a cam surface 30 arranged to contact said distal end 40 of said tongue 36 such that as said clamping is moved from said open position to said closed position, said cam surface 32, 34, 35 initially forces said distal end 40 of said tongue 36 inwardly.

6. The clamping arrangement of claim 5 wherein said clamping arrangement forms an end portion of said outer pole.

7. The clamping arrangement of claim 6 wherein said cam surface 32, 34, 35 is such that following said movement of said distal end 40 of said tongue 36 inwardly, said tongue is permitted to move slightly outwardly upon continued movement of said clamping member 24.

8. The clamping arrangement of claim 6 wherein said tongue 36 and said clamping member 24 interlock 44, 46 when said clamping member is moved to said closed position.

9. The clamping arrangement of claim 6 wherein said inner pole and said outer pole and said receptacle 22 are cylindrical in configuration.
